(19) United States
(12) Patent Application Publication
(10) Pub. No.: US 2017/0270809 A1
(43) Pub. Date: Sep. 21, 2017

(54) METHOD AND APPARATUS FOR TEACHING SCIENCE CONCEPTS

(71) Applicant: Knowing Science LLC, Armonk, NY (US)

(72) Inventor: William Banko, Armonk, NY (US)

(21) Appl. No.: 15/610,399

(22) Filed: May 31, 2017

Related U.S. Application Data
(63) Continuation-in-part of application No. 12/717,376, filed on Mar. 4, 2010, now abandoned.

(51) Int. Cl. G09B 1/34; G09B 19/00; G09B 5/06

(52) U.S. Cl. CPC G09B 1/34; G09B 5/065; G09B 19/00

(57) ABSTRACT

A method and apparatus enable a teacher to teach science to a young student using the student's existing life experience acquired knowledge and skill set. A sensory physical activity relating to a concept to be taught is designed for the student to witness and perform in order to provide a sensory experience that is embedded in the brain, the student thereby learning the concept which later can be used to learn a scientific principle. Details of the activity steps are documented for use by the teacher to provide a source for the demonstration and explanation of the activity. An apparatus is provided with various implements with which the principles can be demonstrated.

This application is a continuation-in-part of co-pending U.S. patent application Ser. No. 12/717,376 filed Mar. 4, 2010, which is incorporated herein by reference in its entirety.

### FIELD OF THE INVENTION

The invention relates to a method of teaching concepts of science to students, particularly young students and the application of the concepts to scientific principles.

### BACKGROUND OF THE INVENTION

It is generally accepted that the teaching of science in the United States to students is not done in a proper manner and has yielded poor results. Many articles have concluded that science education in the United States is a major problem that greatly weakens the intellectual resources of the country. For example, see the editorial from Science Magazine—SCIENCE VOL 323, 23 JAN. 2009 which basically concludes that science education is in a crisis in the United States. Also of interest is Introduction from Hazen R. & Trefil J., Science Matters, New York, Anchor Books (2009) which reaches the conclusion that most college graduates in this country do not have basic science literacy. Most educators and others agree that teaching of science must be improved in order for the United States to be able to compete in a global environment.

A number of reasons have been given for why the teaching of science is in such a poor state. Included among these are that most teachers are not comfortable with their own knowledge of science and scientific principles. This makes teaching the subject to students very difficult. For example, at the elementary school levels, many of the teachers responsible for teaching science do not have the knowledge needed to teach the subject since they have majored in English, liberal arts or other non-scientific disciplines. Since they do not understand the fundamental principles of science they feel uncomfortable in the subject and have no desire for teaching it. Even though these negative factors exist, many teaching curricula require that such teachers teach basic science to children in the early grades. Such teachers do not have methods or materials of a type available which will enable them to be able to clearly explain and teach scientific concepts to young students in kindergarten and elementary school. Some school systems deal with the problem by not incorporating the teaching of science concepts to such young students in their teaching curricula or delaying the teaching until later years.

Another reason for the poor results in teaching science is that very young students such as in kindergarten and beginning elementary school grades are assumed not to have developed the cognitive and intellectual skills needed to understand basic concepts of science. This assumption has been proven to be wrong. Children have an existing base of knowledge and set of skills developed by early life experience that are acquired naturally by social interaction or taught to them by others outside of a structured school environment. Such skills include, for example, motor functions such as striking a mobile, rolling a ball, moving and placing blocks, distinguishing different size objects, etc. The skill set size and complexity increases as a child grows older.

Also, a child can absorb much more knowledge at an early age than many people think possible. Some articles say that children as young as 18 months recognize the difference between certain geometrical shapes. Because of failing to recognize a young child's intuitive natural ability to learn, available teaching materials do not take advantage of the existing knowledge and skill set of a young child in a manner such as to promote science education in kindergarten and elementary school.

Programs exist which try to introduce science and scientific concepts to children, for example;

1. NSES and the New Programs. The National Science Education Standards offer criteria for excellence including K-8 science programs and improving science teaching, learning and assessment.

2. BSCS Science TRACS (Teaching Relevant Activities for Concepts and Skills). BSCS TRACS is a comprehensive, modular, kit-based elementary school science program that includes a full year of instructions at each grade level, K-5.

3. The Full Option Science System (FOSS). FOSS is a program designed to serve both regular and special education students in a wide cross section of schools.

4. Insights: An Inquiry-Based Elementary School Science Curriculum. “Insights” is a program that targets urban schools and city school children. The program includes activity-based modules that can be used separately within another science curriculum or as a full curriculum within the life, earth, and physical sciences.

5. Science and Technology for Children (STC). The National Science Resources Center in Washington, DC has put together a resource guide for elementary science teachers that was published by the National Academy Press. They have also been working on 24 science units on Science and Technology for Children. They are now available from Carolina Biological Supply Company.

6. Great Explorations in Mathematics and Science (GEMS). This flexible, integrated math and science curriculum comes to us from the Lawrence Hall of Science (Berkeley, Calif.).

7. Activities That Integrate Mathematics and Science (AIMS). “AIMS” is a series of books that gives children real-life experience in mathematics and science.

In summary, currently existing resources do not appear to describe exact directions (methods) or processes (descriptions) of how to teach science to young children in a manner that takes advantage of the child's acquired knowledge and skill set based on early age life experience and social interaction.

### SUMMARY OF THE INVENTION

The invention is directed to a novel method to teach science and scientific concepts, especially to young children, such as of kindergarten and early grade age. The invention takes advantage of and builds on a child's already acquired knowledge and skill set. It also takes advantage of and builds on a child's natural curiosity to learn and the fact that the ability to learn is at its peak neurophysiological level at a young age. See A. N. Meltzoff, et al., ‘Foundations for a New Science of Learning”, Science 325, 284 (2009).

The first step of the method involves analyzing already acquired knowledge and available skills of a student group to be taught a concept. It should be understood that, for example, children at a second grade age level have a larger database embedded in the brain of acquired knowledge and motor skills than children of kindergarten age. This is because the older second grade children have had a longer time of social interaction, such as by having viewed more incidents and having had more procedures taught, than children of kindergarten age. For example, the older child can play more advanced types of physical games and board games. The acquired knowledge and skill set for a student group of a particular age would have a Gaussian type distribution and the analysis preferably would concentrate at the levels of knowledge and skills at the center of the distribution curve.

Next, there is a selection of the science concept or part of the concept to be taught. The concept selection should not be beyond the comprehension of the age group. For example, it would not be reasonable to select a concept such as liquid f low rate to teach to kindergarten age children. A more reasonable selection for this age group would be concepts such as measurement of size, distance and time, the latter two being necessary to understand the principle of velocity. Teaching these concepts to a kindergarten student provides the building blocks which would form the basis for teaching velocity when the student is older.

The next step in the method is in designing an activity that will physically demonstrate the concept. It is preferred that the activity involves use of as many of the sensory functions of touch and sight as possible since it is considered that the more sensory functions that are involved the more effective will be the learning experience for the student. It is believed that the success of embedding a concept in the brain increases with greater use of sensory functions. It also is possible to design activities that would include sound and smell sensory functions. The activity design also preferably includes physical activity that involves the sensory functions and social interactions with a teacher, who will demonstrate the activity, and with the peers of his group whom he can watch perform the activity.

As an adjunct to this step, documentary materials such as a brochure or workbook or DVD presentations are prepared for use by the teacher. These will have a detailed description or view of the activity. Written materials preferably have illustrations of the steps of the activity and suggestions on how to demonstrate it to the children. The suggestions would include questions to ask the students during various parts of the demonstration. The teacher would review and learn from these materials. The written materials are designed so that the activity steps are simple and the teacher does not need a scientific background to demonstrate them.

After the concept teaching activity has been designed and the written materials produced for it are understood by the teacher, the teacher demonstrates it to the student or group of students. The demonstration preferably includes the teacher explaining to the student group what he/she is doing. It is not necessary to explain to very young students the name of the concept or the reason why it is being taught. The idea of the method is to teach the concept and embed it in the student's brain neural pathways.

Next, after watching the demonstration and listen to an explanation, the student is made to perform the activity. The student will have a background for doing this having already witnessed the teacher perform the activity and explain it. In a sense, the student will be imitating the teacher's performance. Young children have an innate ability to imitate. Here, if there is a group of students seeing the teacher perform the activity, the teacher might want to select the first student with a higher knowledge and skill level so that the other students watching would see a successful performance and not a failure. The student can be given several attempts to achieve success in performing the activity.

Another step in the method is having the student witness others performing the activity. The student will first see the teacher doing this and may see other students do it both before and after the turn of the student. Watching the demonstration before performing the activity gives the student more confidence that the activity can be performed. Watching others repeat what the student has already done provides reinforcement.

As a final part of the activity performance step there can be an expansion of the activity and a teacher demonstration and student performance of the expanded activity.

The method of the invention enables a teacher to teach science drawing on the existing life experience acquired knowledge and skill set of a young student. The method is structured into a sensory physical activity for the child to witness and perform in order to provide an experience that is embedded in the brain, the student thereby learning a concept of science. The embedded concept later can be used to learn a scientific principle.

### BRIEF DESCRIPTION OF THE DRAWINGS

The foregoing and other objects and advantages of the present invention will become more apparent when considered in connection with the following detailed description and appended drawings in which like designations denote like elements in the various views, and wherein:

FIG. 1 is a flow chart showing the steps of the method; and

FIG. 2 is an illustration of apparatus that can be used to carry out the teaching methods according to the present invention.

### DETAILED DESCRIPTION OF EXEMPLARY EMBODIMENTS OF THE INVENTION

The Method of Teaching

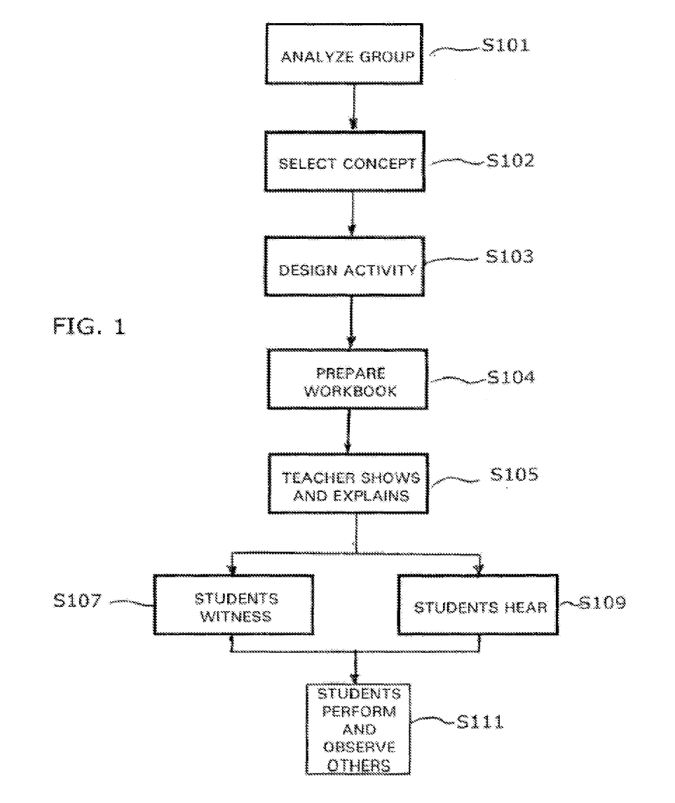

Referring to FIG. 1, in step S101 a person or group of people analyze the knowledge and skill set level of a single student or group of students to be taught a concept relating to science. This is done by standardized tests, specialists who come in to evaluate the students for their reading, comprehension, writing skills etc., and by the teachers. This step sets the basis for activities related to a concept of science to be designed and demonstrated to the student, and then performed by the student, in later steps of the method.

The knowledge and skill set of the student or student group already has been acquired from the life experiences encountered. For example, even the youngest children recognize the difference between light and dark. Objects of different shapes are recognizable although the child could not give a name to a square or a circle. Recognizing objects of different size also is pretty much of an innate bit of knowledge with many children usually choosing the largest item present. Young children also possess motor skills such as being able to throw an object, roll a ball, stack blocks, pick up a cup, maneuver a spoon to the mouth, etc. A child uses these skills in various activities of play and daily living. The child often imitates what he has seen in developing his knowledge and skills.

In any child or group of children the acquired knowledge and skill set is largely a function of age. It should be understood that, for example, children at a second grade age level have a larger database in the brain of acquired knowledge, such as by incidents viewed and procedures taught, than children of kindergarten age.

The acquired knowledge and skill set for a particular age group would have a Gaussian type distribution and the analysis preferably would concentrate at the levels of knowledge and skills at the center of the distribution curve. Thus, in analyzing the knowledge and skill set level of a group of students of kindergarten age, the analyzer would preferably select the middle of the curve.

In S102 the method selects the scientific concept to be taught to the student or student group. For example, consider that it is decided to teach the basics of measurement, which is basic to all scientific principles. This includes measurement of sizes of object, distance, weight and time. These are building blocks for understanding many scientific principles. For example, the principle of velocity is distance/time. When students understand the concepts of distance and time, they have a firm foundation for later learning and understanding the principle of velocity.

Based on the results of the analysis in S101 of the already acquired knowledge and skill set and selection of the concept to be taught in S102, in S103 an activity is designed that will be used to teach the selected concept. In general, activities are designed by age with more complex activities addressed for older children. Also, it is preferred that the design include physical activity. When a student is involved in a physical activity, the student's entire body obtains sensory input and learning becomes a physical experience, as opposed to the brain just remembering facts that the student hears or reads.

An aspect of the activity design is based on neurological principles. Neuroscience has identified two critical processes which result in more effortless learning by children. Children rely on social interaction as the essential method of understanding the world around them. Some of the components of social interaction include imitation and shared attention. Children learn most effectively when they participate in activities that are designed with built-in imitation and social components in order to specifically teach a basic science concept. The activities are designed with this in mind. Several are described in detail below.

In S104 written materials such as a brochure or workbook are prepared for use by the teacher. These will be a step by step detailed description of the activity preferably with illustrations of the steps. A simple explanation of the reason for each step also can be given as well as suggestions on how to demonstrate and explain the step to the children. The suggestions would include questions to ask the students during various parts of the demonstration. The written materials are designed with the goals to be understandable by an adult teacher with average intelligence and to make the teacher feel comfortable and have confidence in being able to make the presentation of the activity to the students. The written materials are designed so that the activity steps are simple and the teacher does not need a scientific background to understand them. The teacher reviews and learns from these materials.

In S105 the teacher demonstrates the activity steps and explains what he/she is doing. In S107 the student witnesses the demonstration and listens to the explanation given by the teacher. After seeing the teacher's demonstration and listening to its explanation in S109 the student performs the activity in S111. Students witness other students performing the activity. Steps S109 and S111 have no mandatory presentation sequence. When a student performs the activity he already has seen it performed at least by the teacher. If the student is in a group of students and is not the first performer of the activity, he will have seen it demonstrated by one or more of his peers. One or more students probably will also voluntarily verbally comment on his own activity performance or on the activity performance of another student. Thus, the student's performance of the activity will involve social interaction with at least the teacher and his student group peers. The interaction enhances learning of the concept.

Described below are several activities directed to teaching concepts related to measurement. The description is of a concept that has been selected in S102 and for which the described activity has been designed. The concepts described basically are for kindergarten or even pre-school students. The invention is not limited to the described activities, which are by way of example, or being directed to any particular age group. The description inherently describes the teacher's demonstration of the activity for this selected concept.
1. Comparing (Size and Weight)

Comparing properties of objects is one of the fundamental concepts needed in understanding science. In the designed activity for this concept the teacher starts with two objects, such as two books of different size and of different weight. The properties of size and weight of the different objects are demonstrated and explained to the students in terms of which book is larger than the other, which one feels heavier than the other, etc.

Each student is then given a set of the two books of different sizes, to hold, one in each hand. Each student practices determining which book is bigger/smaller and heavier/lighter. The teacher can direct the student to place and/or switch the heavier/lighter book from one hand to the other. The teacher will observe and comment and the students will watch their peers. The activity makes the students compare the objects. This enables them to verbalize the similarities and differences of the objects. When the student has verbalized the differences in properties, the intuitive understanding of the principle of comparison is reinforced.

The next step of the activity calls for the teacher to demonstrate placing the smaller book on top of the larger one, and vice versa, and then direct the students to do this on their desk or on a table. The students watch others of their group doing this. The next step is for the teacher to demonstrate and explain standing the larger to smaller books from left to right (or using some point of reference like the end of a table if some of the students do not know left from right) and vice versa. Here to, the students are directed to do this and they watch others in their group doing the step. The teacher observes and explains corrections and suggestions to the group.

Another book of a different size can be introduced into the activity and the teacher demonstrates and explains the relative sizes between the three books. The teacher then demonstrates and explains stacking the books next to each other in size (height) order or to place them one on top of the other in size order. Next the students place the books side by side or one on top of the other in size order to confirm their impression of which is bigger or smaller. Here also, they observe other students in their group.

All of the activities can be done on a group basis with the teacher supervising and explaining as needed or each student performing the activity with the other watching. Using the latter approach, each student in a group gets a turn, so that everyone gets to participate. The student's correct performance is enhanced by watching and imitating those who preceded him and his own physical performance is more securely embedded by watching the other students.

By holding the objects in their hands, the students experience tactile (touch) and visual sensory input to the brain. The visual input is provided by viewing others perform the activity. Since birth, children have been holding and comparing objects, and they have this skill well developed. The hearing sense is utilizes by the student listening to the teacher and to others in the peer group. The sensory input embeds the concept in the student's brain.
2. Measurement with Standard Units and Understanding Distance.

The skill of comparison provides a stepping stone to understanding the fundamental concept behind measurement. The method normalizes an intuitive skill by giving it a name: “Comparing Properties of Objects”.

In this activity an arbitrary object is chosen and labeled as the standard. The teacher demonstrates and explains comparing similar objects to this standard. This reinforces the principle that when an object is chosen as a standard (measuring unit) that object can be used to sort similar objects in size groups. For example, the teacher takes a book, labels it as standard # 1. Each student compares their own book or books to this standard and determines whether it's bigger or smaller than the standard. The other students observe and the student's comparison result is verbalized so that all of the other students can hear it.

As a next step in the activity the teacher demonstrates and explains sorting objects by comparing them to the standard. For example using a number of objects these are compared one by one to the standard and placed in groups classified as being larger or smaller than the standard. The students individually do this all at the same time or in sequence as other students observe.

The next step is to give the students a real measuring unit, for example, an inch cube. The teacher demonstrates and explains to the students taking cubes, placing them side-by-side next to an object and comparing and counting the number of cubes required in order to match the dimension of the object. The students perform this step. The student is now developing the skill of measuring objects. This step can be expanded on by the use of a ruler with the one inch markings and the students taught the relationship of a number of the one inch measuring blocks previously used to the one inch ruler markings. The concept of size relationships and measuring acquired through the physical and sensory activities are embedded in the brain.

The measuring activities described above establish an intuitive understanding of the concept of distance. The teacher first demonstrates and explains and the students then perform marking two points on a piece of paper and then measuring the distance between the two points. For example, it may take six (or some other number) cubes placed side by side to span the distance between the points. The students learn the concept of distance by making the distance between the points greater or smaller. The concept of cubes can be expanded to the one inch marks on a ruler or tape measure. With this background of the distance concept, the measuring concept can be expanded to measuring the distance between objects in the classroom.

When every student can measure distance between two points the concept of distance can be expanded to the teacher demonstrating and the students performing determining the distance that an object has traveled. Here an object is moved from an initial to a final position and the distance between the two is measured. Every student can measure the distance an object moved, after marking the initial and final position of the object. The distances can be different. Teaching and learning this concept is a cornerstone of teaching mechanics. The knowledge of the concept is one that applies to many scientific principles.
3. Time

A standard time unit is selected and demonstrated to the students. The standard unit can be the teacher counting one, two, three, etc. Preferably an instrument such as a metronome is used that is set to one second beats. The teacher demonstrates by counting with each beat. The students are watching the metronome swinging arm action as the counting takes place. The teacher asks the students to join in the counting.

Next the teacher walks across the room from one point to another or asks one of the students to do it. The teacher or student starts to walk between the two points on a metronome beat and the students count out loud the number of beats that it takes to walk between the two points. Different students are asked to walk between the two points and the number of metronome beats is counted for each. A student is directed to walk slowly and then is directed to run between the two points as the counting takes place. The students will see that it takes more beats of the metronome when walking slowly than when running.

The concept of time, in terms of the number of metronome beats, is embedded in the brain enhanced by sight, sound and social interaction. While young students may not understand the time measurement units of seconds, they experience and understand that it takes longer to travel the distance between the two points in terms of the number of metronome beats they count when walking slowly than when running.
4. Gravity

Each student should hold an object in his or her hand and drop it so that it hits the floor. The teacher explains to the students that all objects fall because of the Earth's gravitational force attracts everything. The teacher should try to explain that is this force that keeps people from floating away. The students, while not fully understanding gravitational force, will be embedded within idea that something is holding objects down to the earth.

The teacher sets up a board as an inclined plane whose angle can be adjusted. For example, a stack of books can be set up on which the head of the board is placed with the board foot resting on a table or on the floor. This permits the adjustment of the incline of the board by removing or adding books. A ball is placed at the end of the board and permitted to roll down. The students see the place where the ball stops rolling on the table or the floor. Next the teacher adjusts the angle of the incline of the board and repeats the rolling of the ball. Depending on whether the angle of inclination has been increased or decreased, the ball will roll a longer or shorter distance from the foot of the board. The students can individually repeat these steps. This teaches the students the concept that objects are caused to move in the direction of the force of gravity.

This activity can be expanded by measuring the time that it takes for the ball to roll down the inclined plane and showing that the smaller the angle, the shorter will be the time duration. When the angle is zero, the ball does not move. When it is 90° the ball is accelerated by the force of gravity produced by the earth. As seen, the method of the invention provides sensory experiences and social interaction related to a concept being taught. The sensory input enhanced by the social interaction results in the concept becoming embedded in the child's brain where it is available to be used for learning more advanced concepts and scientific principles based on the concepts.
The Teaching Apparatus

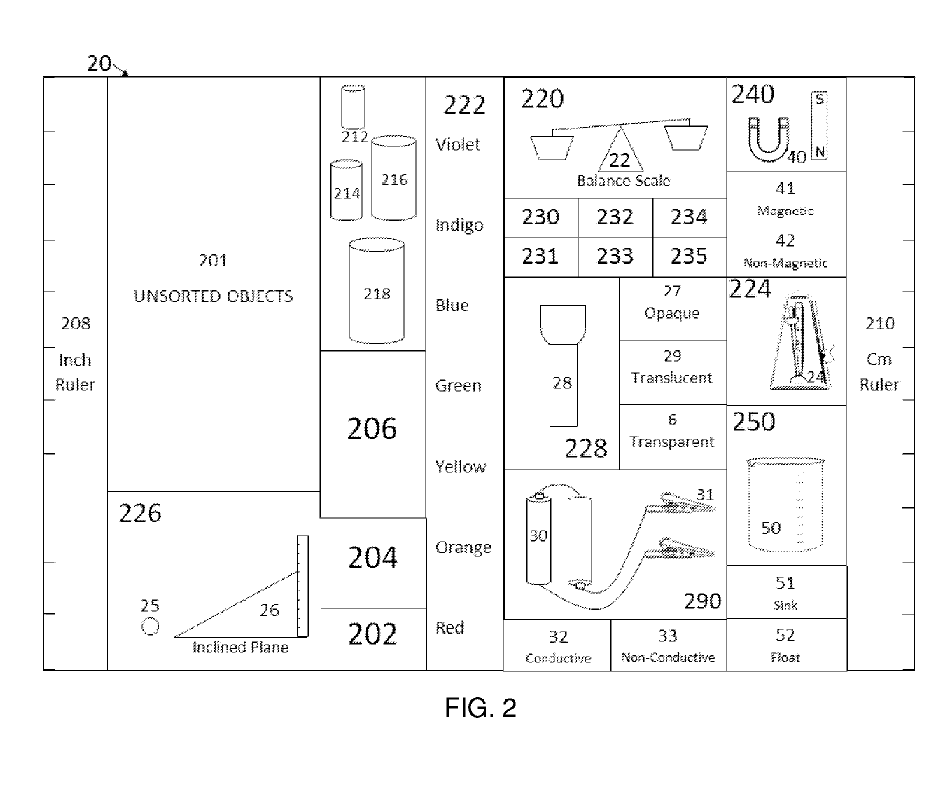

FIG. 2 shows apparatus for teaching the concepts of the present invention. The apparatus is in the form of a box with low walls and a base or a tray 20. The tray has a number of compartments dedicated to apparatus for teaching the various concepts discussed above. Although not repeated here in detail, the same teaching concepts described above can be used, e.g., the teacher demonstrates the task first, a few students do it next and finally the entire group participates after having seen it performed several times.

Compartment 201 contains a variety of three dimensional objects useful in teaching concepts. For example it contains (a) cubic shapes that may be, for example, one inch on each side, (b) cuboid shapes that may have a one inch square cross section but is two inches in length and (c) cuboid shapes that are one inch square in cross section and three inches in length. As will be noted below, having standard lengths for the objects is helpful in teaching a measurement concept. Also, these shapes may have different weights, e.g., 2 ounces, 4 ounces and 6 ounces. In one embodiment the objects of different weight may be of a different color so the child can associate a weight with a color. In addition the objects in compartment 201 may include spheres of different size and weight, where those of the same weight may be of the same color. Further, rectangular objects and circular objects of the same weight may have the same color. At least one rectangular object and one spherical object can be designated as standards and can be given a special color, e.g., gold. A standard object would be selected to be in the middle of the size and weight range of the other objects so that the size and weight comparisons described above can be carried out.

A student can be instructed to pick out the gold cuboid. Although the student will not know this at the beginning of the lessons, it is a two inch cuboid that weighs 4 ounces. Then the student is asked to select another rectangular object from compartment 201 and to hold it next to the gold standard. The student determines whether the other object is bigger, smaller or the same as the standard as discussed above. Then the teacher tells the student to place the other object in a compartment 202 if it is smaller, compartment 204 if it is the same or compartment 206 if it is larger. Then the student can select another object and compare it to the gold standard and do another sort. This can continue for a set period or until all of the rectangular objects are sorted.

It should be noted that compartments 202, 204 and 206 are of different sizes, sizes intended to be slightly larger than the related objects. As a result, if the student incorrectly sorts the objects, the attempt to fit a larger object into a smaller compartment will indicate to the student that a mistake has been made. As an alternative, the objects may be sorted by comparing them to the sizes of the compartments without the use of a standard.

An inch ruler 208 is located along one side of tray 20 and a centimeter ruler 210 is located along the other side. The objects selected can be placed along the rulers and the students taught to measure them after they have been sorted. This provides a link for the student between the perception of size difference and measurement. The rulers can be made to be detached from the tray 20 so they can be used for distance measurements as described above.

In the tray next to the compartments for the rectangular objects there are cylinders of different diameter 212, 214, 216, 218. A sorting exercise can be carried out by comparing the spherical objects to a gold standard sphere and sorting them into the cylinders. As an alternative if the cylinders are made slightly wider in diameter than the various sizes of spheres, they can be sorted by comparing the spheres to the cylinder openings or errors in sorting by comparison to the gold sphere can be detected when a sphere will not fit into the designated cylinder.

Because the cuboids and spheres have different weights the students can be asked to compare the weight of a random object to that of one of the golden standards. The student can determine if the object is lighter, the same or heavier than the standard and can be asked to sort on that basis. The results of this sort can be placed in compartments 230, 232, 234, which have other uses as will be described below. As a variation, the standard for the spheres can be the golden standard cuboid and vice versa.

An extended compartment 222 is provided. It has various colors labeled in it. The color indication is spelled out in letters which are in the appropriate color. As one exercise, the students can be asked to stack the colored cuboids on top of the color indication to teach them to sort by color.

A balance beam scale 22 is provided in a compartment 220 of the tray. It can be used to more accurately measure weight differences. For example, once the student has done a weight comparison, it can be confirmed by placing the objects in the balance beam to confirm that the heavier one moves down while the lighter one moves up. In addition to the objects in compartment 201, a set of standard weights can be located in the compartment with the balance beam. These can be for example 1, 2, 5, 10, 50 and 100 grams. The students can compare the objects to these standard weights and sort them into compartments 230, 232, 234 as well as compartments 231, 233, 235 as shown. Further, the child can be directed to place an object on one side of the balance beam scale and to add the weights to the other side until it is in balance. Then the child can count or add up the total weight added to determine the weight of the object.

A compartment 224 contains a metronome 24 which can be used to demonstrate time to the students. As described above, the students can count the swing of the metronome as some activity is carried out to get a sense of time.

In compartment 226 there is provided a ramp 26 and a ball 25. These are used to demonstrate the effects of gravity to the students as described above, by setting the ramp at different heights and rolling the ball down it. Also, the metronome 24 can be used to time the movement of the ball.

A flashlight 28 is provided in compartment 228. Along with it there are provided opaque, translucent and transparent objects, 27 29 and 6. Light from the flashlight is caused to shine on the objects and the students can observe whether the light passes through the object or not. This is a more advanced concept, i.e., properties of light.

A compartment 290 has batteries 30 which are wired in series to increase their combined voltage. The batteries can be set up to provide power to the flashlight 28. Further, conductive material 32 and non-conductive material 33 are provided. These can be alternatively placed in the line from the batteries to the flashlight by clips 31. When conductive material is used the flashlight can turn on. When non-conductive material is used it will not. This teaches the students another advanced concept, electrical conductivity.

In compartment 240 there are magnets 40, magnetic objects 41 and non-magnetic objects 42. These can be used to teach the students about magnetic attraction, i.e., that some materials are attracted by magnets and some are not.

A compartment 250 contains a beaker 50 that can be filled with water. Along with beaker 50 are provided objects that sink 51 and objects that float 52. First floating and non-floating objects can be demonstrated. Then the weight of the objects can be measured with the balance beam scale 22 to show that heavier objects of the same dimension sink, while lighter ones may not. These can be the objects from compartment 201.

The objects used throughout this apparatus may be made of different materials, including wood, plastics, metals, etc. Also, as demonstrated, parts of the apparatus can be used in the demonstration of more than one scientific principle.

Specific features of the invention are shown in one or more of the drawings for convenience only, as each feature may be combined with other features in accordance with the invention. Alternative embodiments will be recognized by those skilled in the art and are intended to be included within the scope of the claims. Accordingly, the above description should be construed as illustrating and not limiting the scope of the invention. All such obvious changes and modifications are within the patented scope of the appended claims.

I claim:

1. An apparatus for teaching scientific principles to children comprising:
a base to support the apparatus;
a plurality of open top compartments located on the base;
a plurality of objects located in a first of the compartments, said objects having at least one property that is perceivable with at least three different values, whereby a child can compare the property of any two of the objects and determine which has the larger value;
a second of the compartments being provided, whereby the child can be directed to place one of the object based on the perceived value.

2. An apparatus for teaching scientific principles as claimed in claim 1 wherein the property is a dimension of the objects, one of the objects is a standard size object having a median dimension, whereby a child can compare other objects to the standard size object and determine whether the other objects are smaller, the same or larger than the standard size object; and
further including third and fourth compartments, wherein the child can be directed to place other objects smaller than the standard size object in the second compartment, objects equal to the standard size object in the third compartment and objects larger than the standard size object in the fourth compartment.

3. An apparatus for teaching scientific principles as claimed in claim 2 wherein the dimension of the second compartment is slightly greater than the smaller objects, the dimension of the third compartment is slightly greater than the standard object and the dimension of the fourth compartment is slightly greater than the larger objects.

4. An apparatus for teaching scientific principles as claimed in claim 3 wherein the objects are cuboids of a uniform cross section and standard increments of length, and the second, third and fourth compartments are rectangular boxes.

5. An apparatus for teaching scientific principles as clamed in claim 4 further including at least one ruler, wherein the child can be directed to compare the length of the cuboids to increments on the ruler to determine length.

6. An apparatus for teaching scientific principles as claimed in claim 3 wherein the objects are spheres with standard increments of diameter, and the second, third and fourth compartments are cylinders.

7. An apparatus for teaching scientific principles as claimed in claim 6 wherein the shape of the second cylinder is slightly greater than the diameter of the smaller spheres, the shape of the third cylinder is slightly greater than the standard sphere and the shape of the fourth cylinder is slightly greater than the larger sphere.

8. An apparatus for teaching scientific principles as claimed in claim 1 wherein the property is color, wherein the objects have a variety of colors and a fifth compartment has different colors labeled in it, whereby the children are directed to place the objects next to the color labels in the fifth compartment.

9. An apparatus for teaching scientific principles as claimed in claim 1 wherein the property is a weight of the objects, wherein the objects have at least three different weights, one standard weight object having a median weight, whereby a child can compare the other shape objects to the standard weight object and determine whether the other objects are lighter, the same or heavier than the standard weight object, and
further including fifth, sixth and seventh compartments, wherein the child can be directed to place other objects lighter than the standard weight object in the fifth compartment, objects equal to the standard weight object in the sixth compartment and objects heavier than the standard weight object in the seventh compartment.

10. An apparatus for teaching scientific principles as claimed in claim 1 further including an eighth compartment containing a balance beam scale and a collection of weights, wherein the property is weight and the child can be directed to place an object on one side of the balance beam scale and to add weights to the other side until it is in balance, and then to count the total weight added.

11. An apparatus for teaching scientific principles as claimed in claim 1 further including a ninth compartment with and inclined plane and a ball, whereby the inclined plane and be set at different inclinations and the child can be directed to roll the ball down the inclined plane and to measure the distance it travels after the end of the plane.

12. An apparatus for teaching scientific principles as claimed in claim 11 further including a metronome for determining time, wherein the child can be directed to count the beats of the metronome until the ball stops rolling.

13. An apparatus for teaching scientific principles as claimed in claim 1 further including a tenth compartment with a flash light and opaque, translucent and transparent light transmission objects, whereby the child can be directed to shine light from the light through the objects to determine which are opaque, translucent and transparent based on the amount of light passing through the object.

14. An apparatus for teaching scientific principles as claimed in claim 13 further including an eleventh compartment with at least one battery connected to clips and electrical conductive and non-conductive objects, whereby the battery can be attached to power the flashlight in the tenth compartment and the child can be directed to determine which of the conductive, non-conductive objects can conduct electricity and cause the flash light to light.

15. An apparatus for teaching scientific principles as claimed in claim 1 further including a twelfth compartment with a magnet, non-magnetic objects and magnetic objects, whereby the child can be directed to determine which of the magnetic, non-magnetic objects are attracted by the magnet.

16. An apparatus for teaching scientific principles as claimed in claim 1 further including a thirteenth compartment with a beaker, floating objects and sinking objects, whereby, after filling the beaker with water, the child can be directed to place the objects in the water to determine if the float or sink.

17. An apparatus for teaching scientific principles as claimed in claim 16 further wherein the objects that sink are compared by weight and size to the objects that float either by the child holding them or placing them in a balance beam scale in an eight compartment.

18. A method of teaching a concept relating to a scientific principle to children comprising the steps of:
analyzing the existing knowledge and available skills of at least one student of an age group;
selecting a concept to be taught to the at least one student;
designing an activity that includes a physical activity that includes at least one sensory function of the at least one student;
demonstrating the activity to the at least one student; and
causing the at least one student to perform the activity.

19. The method as claimed in claim 18 wherein the at least one student is part of a group of students of the same age group and further comprising the step of:
causing a student to witness one or more other students of the group performing the activity.

20. The method as claim in claim 18 wherein the analyzing step seeks to determine the mean level of knowledge and acquired skills for the group of students of the age group.

21. The method as claimed in claim 18 further comprising the step of preparing documentation of the performance of the activity for use by the teacher.

22. The method as claimed in claim 18 wherein the step of demonstrating includes performing acts that can be viewed and explaining the acts performed.

23. The method as claimed in claim 22 wherein at least one student is part of a group of students of the same age group and the step of comparing further comprises:
a student or group of students witnessing a teacher demonstrating sorting of objects by comparing them to an arbitrary standard.

24. The method as claimed in claim 23 wherein objects smaller than the arbitrary standard are placed in one group and objects larger than the arbitrary standard are placed in another group.

25. The method as claimed in claim 24 wherein a student or group of students physically places objects in different size groups after comparing the objects to the size of an arbitrary standard.

26. The method as claimed in claim 22 wherein at least one student is part of a group of students of the same age group and the activity is comparing and comprises the step of comparing comprises: a student or group of students placing a number of objects of a standard size next to an object to be measured to compare the number of objects of standard size required to match the dimension of the object.

27. The method as claimed in claim 22 wherein the activity is comparing and comprises the step of a student or group of students physically manipulate objects to form synaptic changes of connections in their brain.

28. The method as claimed 22 wherein the activity comprises comparing the size of at least two different objects relative to each other.

29. The method as claimed in claim 28 wherein the activity further comprises comparing the weight of the objects.

30. The method as claimed in claim 22 wherein the activity is measuring and comprises providing a student with an object as a standard of size and comparing other objects to the standard to determine if such other objects are larger or smaller than the standard.

31. The method as claimed in claim 22 wherein the activity is measuring a distance and comprises providing a student with an object as a standard of size, and the student determining how many of such standards are needed to span the distance between two points.

32. The method as claimed in claim 31 wherein the standard is the unit distance markings on one of a ruler or tape measure.

33. The method as claimed in claim 22 wherein the activity is measuring time and comprises a student measuring the duration of an event.

34. The method as claimed in claim 33 wherein the step of measuring time further comprises counting the beats from a metronome.

35. The method as claimed in claim 33 wherein the event is measuring the duration of a ball rolling down a plane whose angle of inclination is adjustable.

36. The method as claimed in claim 22 wherein the activity is demonstrating the effect of gravity.

37. The method as claimed in claim 36 wherein the distance a ball travels is measured when released from an inclined plane whose angle of inclination is adjustable.

38. The method as claimed in claim 22 wherein the activity comprises a student comparing a plurality of objects to one another and describing properties of said objects.

39. The method as claimed in claim 22 wherein the activity comprises a student comparing a plurality of objects to one another and sorting the objects by size.

40. The method as claimed in claim 22 wherein the activity comprises a student comparing a plurality of objects to an arbitrary standard.

41. The method as claimed in claim 22 wherein the activity comprises a student comparing a plurality of standard units to an object.
